(19) United States
(12) Patent Application Publication
(10) Pub. No.: US 2006/0021999 A1
(43) Pub. Date: Feb. 2, 2006

(54) Sports container with automated flow control

(76) Inventor: Leo Jonjic, Croatia (HR)

Correspondence Address: Leo Jonjic, Primorska 31,, Ika-Icici, 51414, HR

(21) Appl. No.: 11/042,934

(22) Filed: Jan. 26, 2005

(30) Foreign Application Priority Data
Jul. 28, 2004 (HR) P20040907A

(51) Int. Cl. G01F 11/06

(52) U.S. Cl. 222/333

(57) ABSTRACT

The present invention provides the art of sports bottles with a new and improved air pump, air passage, switch, and optional dispensing tube combination that has particular utility in sports bottle environments as well as other enviroments such as the art of spray bottles, misters, and the like. The present invention further provides a new and improved sports bottle that embodies the new and improved air pump, air passage and switch combination. In operation, the switch activates the pump when the pressure within a liquid reservoir falls below a predetermined pressure thus causing the liquid to flow at a predictable, substantially contant on-demand flow through a conduit operatively connected to the reservoir when a valve disposed in the conduit is actuated by pressure of a user's mouth and/or teeth.

### RELATED APPLICATIONS

The present application is related to Republic of Croatia Patent Application Number P20040907A, filed on Jul. 28, 2004, and makes claim to priority there pursuant to 35 U.S.C. § 119.

### TECHNICAL FIELD OF THE INVENTION

The present invention broadly relates to the art of automated sports contains. More specifically it relates to a novel air pump/pressure switch module unit that has utility in an automated sports contain environment as well as other environments such as hand spayers and misters.

### BACKGROUND OF THE INVENTION

Most energy consuming activities such a various sports activities often require the expendature of physical activity for extended periods of time. Exemplary, but not exclusive of such activities are: running, bicycling, wind surfing, rock climbing, car racing, motorcycling, in-line skating, auto racing and jogging. During such strenuous activity the human body naturally loses bodily fluids through perspiration. Depending on the physical conditions, intensity of activity and climate conditions, the human body can lose as much as one (1) liter of bodily fluids per hour. If these fluids are not replenished during these times of activity, at best a marked decline in the performance of the activity, or at worst more serious consequences, e.g., heat stroke, can result. Specifically, in the case of sports activities, an athlete's competitive edge will be lost. Thus, the efficient and effective replenishment of lost fluid during such activities has presented a problems to the practitioners of the prior art. Moreover, problems exist among handicap individuals who do not have manual dexterity sufficient to quench themselves.

The prior art has attempted to solve these problems in various ways, as exemplified by the following patents:

U.S. Pat. No. 5,607,087, to Wery, et al., issued Mar. 4, 1997, discloses A pressurized fluid dispensing device for storing and dispensing pressurized fluid, such as water, to individuals during the performance of their particular activity. The pressurized fluid dispensing device may be mounted on a bicycle frame, wheel chair frame, car dash, or may even be worn on the body by mounting the device to what is commonly known as a water bottle or fanny pack located on the waist of the individual. The device includes a fluid vessel, support cage (optional), male coupling member, a vessel cap with a female coupling member with a check valve incorporated within, tubing, actuateable valve, and a pressure adapter with a check valve. The fluid vessel is pressurized by slidingly inserting the pressure adapter and charging the system with a common air pressurizing system. The vessel now acts as a pre-charged cassette and may be sealingly engaged with the male coupling member which activates the one way valve and allows the contents to flow through the tubing to the actuate-able valve. The valve is actuated by deforming the hollow member by activities such as biting with the mouth or pinching with the fingers.

U.S. Pat. No. 5,326,124, to Allemang, issued Jul. 5, 1994, discloses an improved water delivery apparatus which may be adapted to be mounted for use on a bicycle in which water may be delivered to be sprayingly discharged through the sprayer or to a mouthpiece which may be placed in a bicycle rider's mouth to permit water to be discharged directly therein. This apparatus operates with an existing standard water bottle for a bicycle and alleviates the possibility of having a stream of water misdirected, distracting the rider, nor will a rider be caught off-guard receiving a stream of water in the face when a spray was anticipated

U.S. Pat. No. 5,645,404, to Zelenak, issued Jul. 8, 1997, discloses a personal fluid delivery device that includes an electronic pump system and may also include a fluid reservoir system. The fluid reservoir system includes a fluid reservoir and a delivery tube disposed in communication therewith. The electronic pump system includes a pump operable for delivering fluid from the fluid reservoir, an electrical power supply for supplying power to the pump, a dispensing tube operable for providing a passageway for dispensing fluid from the fluid reservoir and an actuating device operable for selectively actuating the pump

U.S. Pat. No. 5,215,231, to Paczonay, issued Jun. 1, 1993, discloses and apparatus for dispensing liquid into the mouth of a bicyclist. The apparatus includes a container with a flexible wall, an adjustable holder for holding the container on a bicycle, a liquid delivery tube extending from the container, and at least one compressor arm that can be actuated by the bicyclist for compressing the container wall and forcing liquid into the liquid delivery tube. Valves connected to the liquid delivery tube prevent back flow of liquid in the direction of the container.

U.S. Pat. No. 5,062,591, to Runkel, issued Nov. 5, 1991, discloses a drinking system for a rider of a bicycle characterized by inflatable upper portion with suitable conduit and valves for conveying the potable beverage stored in the inflatable upper portion to the drinker on the bicycle so the bicycle rider can drink a potable beverage without having to stop the bicycle.

U.S. Pat. No. 4,815,635, to Porter, issued Mar. 28, 1989, discloses a water supply apparatus that can be utilized in conjunction with a bicycle to enable a rider to receive either a spray of cooling water or a stream for drinking purposes. A diaphragm-type pump supplies the water. Plural reservoirs enable a plurality of liquids to be transported and utilized, such as water for cooling the rider and a sucrose solution for energy.

U.S. Pat. No. 4,911,339, to Cushing, issued Mar. 27, 1990, discloses a liquid dispensing apparatus, suitable for mounting on a bicycle safely that provides the rider of the bicycle a way to refresh himself without having to stop and dismount the bicycle. In a preferred embodiment, the apparatus generally includes a cylindrical housing containing a supply of liquid. The liquid is dispensed through an unrestricted length of flexible tubing, leading from the housing to a nozzle which is disposed on the handle bars of the bicycle. A pleated bellows is disposed at the bottom of the housing and forms a chamber for holding compressed air. Each inward stroke of the bellows forces air into the chamber so as to hold the contents under pressure. Adjacent the nozzle, and integrally connected thereto is a hand operated valve which, in its normal state is closed. Depressing the valve forces the liquid out of the container, through the tubing and nozzle, to the rider.

U.S. Pat. No. 6,722,679, to Englert, issued Apr. 20, 2004, discloses a liquid dispensing apparatus, suitable for mounting on a bicycle safely provides the rider of the bicycle a way to refresh himself without having to stop and dismount the bicycle. In a preferred embodiment, the apparatus generally includes a cylindrical housing containing a supply of liquid. The liquid is dispensed through an unrestricted length of flexible tubing, leading from the housing to a nozzle which is disposed on the handle bars of the bicycle. A pleated bellows is disposed at the bottom of the housing and forms a chamber for holding compressed air. Each inward stroke of the bellows forces air into the chamber so as to hold the contents under pressure. Adjacent the nozzle, and integrally connected thereto is a hand operated valve which, in its normal state is closed. Depressing the valve forces the liquid out of the container, through the tubing and nozzle, to the rider.

U.S. Pat. No. 5,735,440, to Regalbuto, issued Apr. 7, 1998, discloses a fluid dispensing apparatus is mounted to and supported by any of numerous sizes and styles of bicycles. The fluid dispensing apparatus has a means for storing water, a means for pressurizing stored water, a means for controlling the release of pressurized water in the form of a plurality of high velocity water jets, a means for independently aiming said water jets, a means for conducting fluid between components, and a means for mounting components to the frame of a bicycle. One embodiment of the invention incorporates one or a plurality of serially connected pressurized water reservoir assemblies, a dual piston-in-cylinder water pump assembly, a manually operated water pump lever assembly, an assembly of multiple independent, manually-activated triggers, and multiple independently aimable nozzles. The reservoir, pump, and trigger assemblies are mounted to and supported by frame members of the bicycle. The nozzles are mounted to the trigger assembly, a point on the frame, or to the helmet or body parts of the rider.

U.S. Pat. No. 5,158,218, to Wery, issued Oct. 27, 1992, discloses a pressurized fluid dispensing device for storing and dispensing pressurized fluid, such as water, to athletes during the performance of their particular activity, particularly endurance events such as a bicycle tour, biathlon, triathlon and the like. The pressurized fluid dispensing device may be mounted to the frame of a bicycle between the vertical and diagonal supports above the center bracket or crank assembly to provide as low as possible center of gravity. The device includes a support cage, fluid vessel, tubing and an actuateable valve. The fluid vessel may be pressurized and slidingly inserted into the support cage to supply fluid through the tubing to the valve. A check valve extends from the bottom of the vessel which is sealingly engageable with a recess formed in the bottom of the support cage through which the fluid may flow. The actuateable valve is actuated to dispense fluid by being bitten. In addition, the actuateable valve may be actuated by hand to spray fluid therefrom to refresh the rider.

U.S. Pat. No. 5,301,860, to Paczonay, issued Apr. 12, 1994, discloses an apparatus for dispensing liquid into the mouth of a bicyclist, the apparatus including a container with a flexible wall, an adjustable holder for holding the container on a bicycle, a liquid delivery tube extending from the container, and at least one compressor arm actuatable by the bicyclist for compressing the container wall and forcing liquid into the liquid delivery tube. Valves connected to the liquid delivery tube prevent back flow of liquid in the direction of the container.

U.S. Pat. No. 5,201,442, to Bakalian, issued Apr. 13, 1993, discloses a remotely actuated apparatus is provided for delivering a liquid to a desired location, particularly for use with a bicycle. The invention includes a reservoir, a pump adapted to receive liquid from the reservoir regardless of the orientation of the reservoir, a delivery tube for delivering liquid from the pump to a desired location, and a remote actuator for remotely actuating the pump. Also included in a preferred embodiment is a manifold which receives liquid from the pump. The manifold has a plurality of outlet ports to facilitate attachment of the delivery tube thereto regardless of the orientation of the apparatus. The actuator is disposed remotely from the reservoir and sends a signal which is received by a receiver means which actuates the pump to dispense refreshment liquid through the manifold to a delivery tube and then to a dispensing tube which is in close proximity to the mouth of the bicycle rider.

Typically, the sports bottles of the prior art include a short straw on the top lid and and a plug on the other end. In order to accomplish hydration, one has to reach out for the bottle, press with their teeth on the plug on the other side of the short straw, tilt their head into an unnatural backward movement, drink by active sucking movements, place the plug back and then return the bottle to the initial placement. In order to complete this complex action, the athlete loses their concentration and disrupts their pattern of breathing, and the action is time consuming.

The majority of the prior art sports bottle designs dispense liquids by suction produced by the mouth of the user. Typically these designs are directed toward polymeric liquid containers that can be placed in a backpack. A straw extends from the backpack, to near the user's mouth. This permits comfort of drinking and may be a suitable solution for some users of the bottle such as joggers and walkers, and the like.

However, from a practical prospective, these designs embody certain drawbacks for the competative athlete. An athelete is in effect, a highly complex system. A highly complex system is subject to drawbacks. These drawbacks can best be illustrated by reference to the “butterfly effect.” Simply stated, when a butterfly flaps its wings in China, it can ultimately effect the weather in New York. The analogy to competitive sports is manifest: the slightest distraction from the athelete's focus, or althelete's slightest waste of energy, can result in a profound effect in performance. As applied to the art of sports bottles, with the typical sports bottle on the market today, the athlete is required to waste valuable energy to produce sufficient oral suction to withdraw the liquid from it. This twofold problem, e.g., (1) the waste of energy; and, (2) distraction from focus on the objective (e.g., winning a competition), although arguably slight, could be sufficient to disrupt the athelete's patterns of breathing; thereby profoundly impairing the athelete's competative edge (e.g., causing the athelte to lose the competition).

Various of the prior art patents (e.g., those cited above) solves the energy waste aspect of the problem through the employment of liquid pumps to force feed the liquid from the sports bottle. However, these inventions have had only met with limited success.

Of those prior art patents cited above, only two (2) employ an electrical switch in a sports bottle environment. These are Zelenak '404 and Bakalian '442.

The mercury switch of Zelenak '404 is preferably operable to selectively actuate the pump based on its orientation. When the Zelenak mercury switch is positioned near the dispensing end of a dispensing tube, this arrangement provides the advantage of making the pump of Zelenak, selectively actuatable based on the manipulation of the dispensing end of the dispensing tube. This arrangement is preferred because it reduces the need for manual dexterity in operating the pump. When the dispensing end of the dispensing tube is oriented in a downward vertical direction, the mercury switch does not permit the electrical circuit with the pump to be completed, so that the pump does not run. Alternatively, when the dispensing end of the dispensing tube is raised in an upwardly vertical direction, the mercury switch permits the electrical connection with the pump to be completed, thereby actuating the pump and causing the pump to remain in operation until the dispensing tube is returned to a downward vertical position, thereby discontinuing the electrical connection with the pump.

Bakalian '442, on the other hand, teaches a pump drive actuating means for actuating the pump drive that typically includes a solenoid switch connected to a radio receiver. Also included in the actuating means is an antenna. A relay is connected between the radio receiver and to a battery, to enable a signal from the remote actuating means to be received by the pump actuator antenna and then to be relayed through the pump drive actuating means to cause the pump drive to drive the pump for a predetermined interval to dispense a specific quantity of liquid into the outer concentric manifold and then into the delivery tube.

Although the Zelenak '404 and Bakalian '442 inventions arguably have some limited success in addressing the waste aspect of the problem, they have little or no impact on the distraction aspect of the problem which is crucial to maintaining a competitive edge in highly competitive sports activities.

In contrast to Zelenak '404 and Bakalian '442, the present invention employs an automated air pump unit having application in a sports bottle environment for providing a substantially constant, predictable on-demand flow of liquid by merely biting down on the dispensing tube of the present invention. As will be described in further detail below, with respect to two (2) of its embodiments, the automated air pump unit is designed to be detachably, attachable in a sports bottle environment. As will be described in further detail below, in a third embodiment, the automated air pump unit is permanently integrated into the sports bottle environment. By providing these alternate embodiments, the present invention solves the problems of energy waste and distraction that have been recognized by the prior art, in any of the attachably, detachable or integrated embodiments reference above.

Thus, it is an object of the invention to provide an new and improved air pump and pressure switch combination module unit that that has particular utility in a sports bottle environment.

It is an object of the invention to provide an new and improved air pump and pressure switch combination module unit that that has broader application in environments other than sports bottle environments, such as a spray bottle or mister environments.

It is a further object of the invention to provide a new and improved sports bottle that employs a new and improved means for providing predictable, substantially constant on-demand flow of thirst quenching liquid to a user.

### SUMMARY OF THE INVENTION

The primary object of the present invention is to provide ready, predictable and substantially constant, on-demand, thirst quenching of participants in physical activities such as sports, wherein the human body is prone to rapid dehydration. A further object of this invention is to provide a device that includes structure enabling it to be mounted a diversity of environments: including but not limited to, exercise equipment, e.g., stairmasters, tread mills, and the like; belt systems adapted, e.g., to be worn around the waiste of the user; and car dash-board mounts, and the like. These expedients are designed to permit hands-free use of the device in these inviroments. The device comprises a container, such as, a bottle or a polymeric bag, either of which is designed with a (typically female) plug connector for enabling detachable, attachment of an elongated flexible despensing tube extending from the bottom of the container. The free end of the dispensing tube is preferably provided with a valve that may, preferably, be acutated by the teeth and/or mouth of the user. As a further refinement, a clip may be mounted on the valve for enabling it to be clipped onto the clothing of the user at a site excessible to the user's mouth (e.g., the lepal or breast pocket). The clip may be similar in design to that of the clip of a pen.

The invention comprises three (3) basic embodiments. The first embodiment is an article of manufacture in the form of an automated air pump/pressure switch module unit for use with a sports bottle. Sports bottles are typically used dispensing a liquid to an individual who is engaged in a physical activity whereby bodily fluids are lost at an accelerated rate though the process of perspiration. The typical sports bottle (or, polymer sports bag, as the case may be) embodies a substantially fluid tight container having an interior for containing both the liquid and an airspace above the liquid. The bottle typically includes a conduit having a valve mounted in it at one end, and structure for fixing the other end. The article of manufacture is a compact module unit that includes a support that has a twofold function. The first function of the support is to securingly integrate the other individual elements of the article. The other function of the support is enable the other elements of article to be sealingly, detachably attached to the bottle as a single unit. The other elements of the module unit include: an air pump having an air intake and an air discharge; a holder for securing a power source for driving the air pump (typically batteries); a pressure switch operatively connected to the air pump that preferably includes high and low pressure sensors; and, structure for enabling the air discharge of the air pump to be detachably attached to the container sufficient to enable the module unit to pump air into the the interior of the container. Optionally, the module unit may include an on/off switch designed to override the automated pressure switch.

The second embodiment of the invention, differs from the first embodiment only in respect to the dispensing tube. In the case of the second embodiment the dispensing is integrated into the unit. As noted above, In the case of the first embodiment, it is not integrated into the unit.

The third embodiment of the invention comprises the all of the elements of the novel automated unit combined with all of the elements of the typical sports bottle system.

The units of the first and second embodiments may be marketed separately from the device; with or without batteries. Alternatively, as in the case of the third embodiment of the invention, the unit can be marketed in combination the device; with or without batteries.

### BRIEF DESCRIPTION OF THE DRAWINGS

FIG. 1 shows a isometric view of the most preferred embodiment of the invention.

FIG. 2 shows a cross-sectional elevation view of an alternate preferred embodiment of the invention having double liquid dispensing conduits.

FIG. 3 shows a cross-sectional elevation view of yet another alternate preferred embodiment of the invention which includes a reserve bottle for increasing liquid volume.

FIG. 4 shows a longitudinal cross-sectional elevation view of the preferred embodiment of the invention depicted in FIG. 1.

FIG. 4A shows the preferred embodiment of FIG. 1 mounted on a bicycle wherein the dispensing conduit is disposed in a non-drinking orientation.

FIG. 4B shows the first preferred embodiment of FIG. 1 mounted on a bicycle wherein the dispensing conduit is disposed in a drinking orientation.

FIG. 5 shows a phantom prospective view of an alternate preferred embodiment of the invention that includes a polymeric bag-type container.

FIG. 5A shows a side cross-sectional elevation view of FIG. 5, depicting the polymeric bag-type container in a filled condition.

FIG. 5B shows a side cross-sectional elevation view of FIG. 5, depicting the polymeric bag-type container in a partially filled condition.

FIG. 6 shows a longitudinal, cross-sectional, fragmentary, detail view of the hands-free valve of the invention, situate at the free end of the flexible dispensing conduit.

FIG. 7 shows a cross-sectional elevation view of an alternative of FIG. 1 that includes a bottom situated, attachably, detachable air pump/pressure switch module unit.

FIG. 7A shows a fragmented cross-sectional elevation view of the alternative of FIG. 1 wherein the bottom portion in its attached condition.

FIG. 7B shows a fragmented cross-sectional elevation view of the alternative of the most preferred embodiment of FIG. 1 wherein the bottom portion is in its detached condition.

FIG. 8A shows a cross-sectional elevation view of an alternate preferred embodiment of the invention depicting a polymeric bag-type container having the detachable novel air pump assembly/pressure switch module unit in its detached condition.

FIG. 8B shows a cross-sectional elevation view of an alternate preferred embodiment of the invention depicting a polymeric bag-type container having the novel detachable air pump assembly/pressure switch module unit assembly in its attached condition.

FIG. 9 shows a cross-sectional elevation view of the invention depicting yet another preferred embodiment with integrated dispensing tube 3 in its attached condition.

FIG. 10 shows a cross-sectional elevation view of the invention depicting the second preferred embodiment with integrated dispensing tube 3 in its detached condition.

FIG. 11 shows a preferred embodiment of the invention secured to a bicycle.

FIG. 11A shows a plan view of the means securing the preferred embodiment of FIG. 11.

### DETAILED DESCRIPTION OF THE INVENTION

The individual automated liquid dispensing system of the present invention includes a polymeric bottle or a polymeric bag-type container, sealingly secured; either permenantly; or, attachably, detachable; to the novel automated air pump/pressure switch module unit structure.

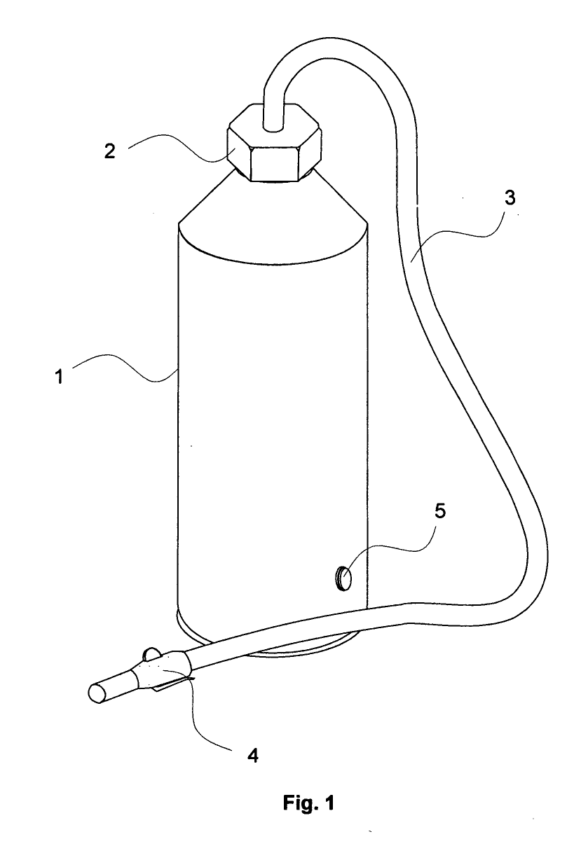

FIG. 1 depicts the basic embodiment of the individual automated liquid dispensing system that includes a bottle 1, having a plug 2, with a flexible conduit 3, and a valve 4. A lower part of the bottle 1 includes the novel powered, pressure switch/air pump assembly module unit (not specifically shown). Plugs 2 may be removed to enable bottle 1 to be re-filled with any suitable liquid, such as water or any sports drink containing electrolytes, such as gatorade™.

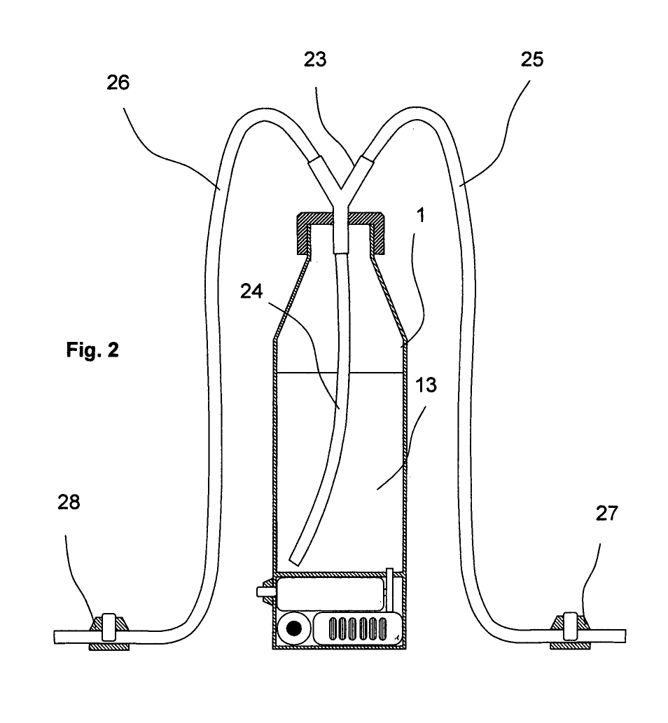

FIG. 2 depicts the individual automated liquid dispensing system bottle 1 used with top plug with a double straw 23 so the same bottle system can be used by two individuals. As in the case in all embodiments of the invention, pressure developed by air pump/pressure switch module unit assembly at the bottom portion bottle 1 forces the liquid contained within 13 through the flexible conduit 24 that branches into two straws (25, 26). Each branch of the flexible conduit has a valve (27, 28). This embodiment of the invention has a preferred application for long automobile or double motorcycling trips wherein a plurality of users is contemplated.

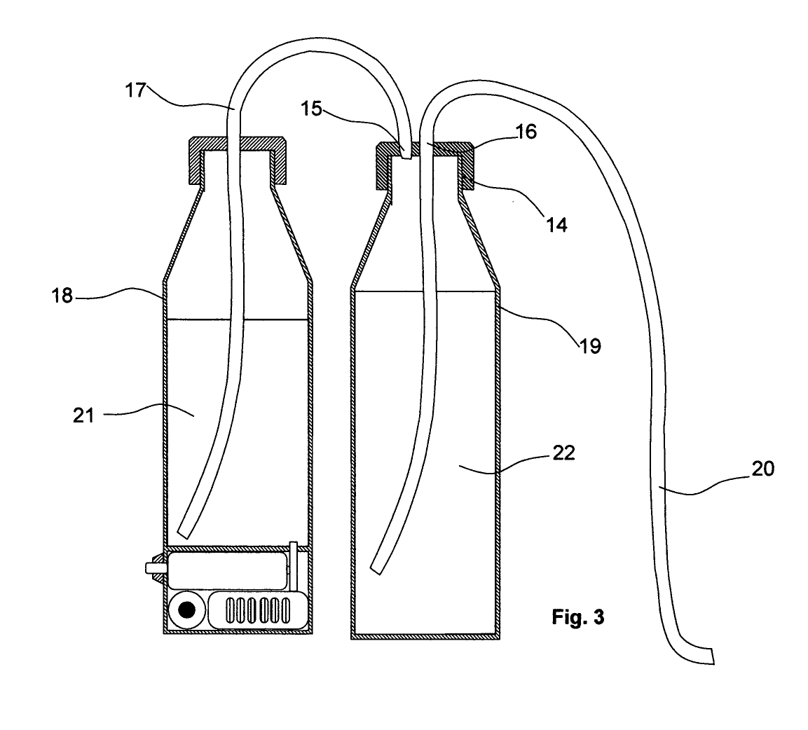

Referring now to FIG. 3; the figure depicts a two bottle dispensing system. Both bottles (18, 19) as a sealed system unit. The bottle 18 of the system contains liquid within its interior 21. That liquid is caused to flow through the flexible conduit 17 into the reserve bottle 19 thereby doubling the liquid capacity of the system. The common pressure of the system operates to force the liquid 22 from the reserve bottle 19 through the flexible conduit 20. When valve 4 (see, e.g., FIG. 1) is caused to be opened, the liquid will be caused to flow through flexible conduit 20. The automated air pump/pressure switch system, as will described in greater detail, infra, functions to maintain sufficient pressure within the system so as to force liquid from bottle 18 and 19 through conduit 20 when the valve is activated.

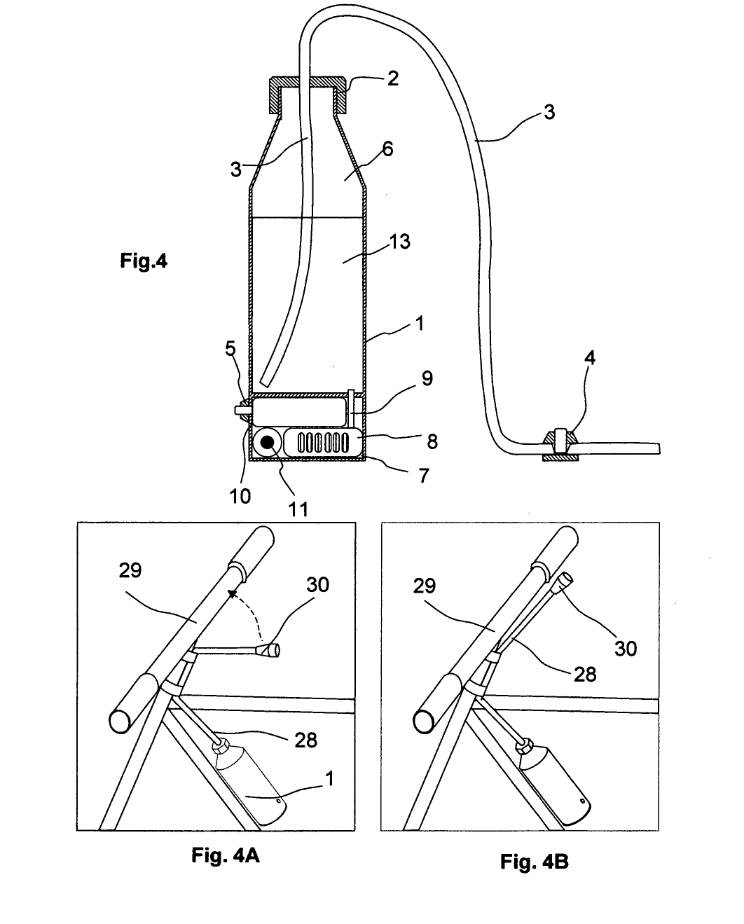

When bottle 18 is emptied, the system will continue pumping the air into a reserve bottle 19 through the flexible conduit 17 until the reservoir of the reserve bottle 17 is emptied as well. The air pump will continue to operate until the maximum set pressure of the high pressure sensor is reached. When the maximum pressure value is reached, air pump 8 will be deactivated by pressure switch 10 as more specifically depicted in FIG. 4, infra.

FIG. 4 depicts bottle 1, divided into two zones; air/liquid reservoir 6; and, the inventive, air pump/pressure switch module unit 7. The module unit 7 contains: an air pump 8 with an air tube 9; a pressure switch 10 that includes a pressure sensors to sense pressure within the interior of the system 6; and, batteries 11. Optionally, pressure switch 10 may include an on/off switch (not shown) for overriding the pressure sensors (this expedient is applicable to all embodiments of the invention). When the on/off switch is toggled to the “on” position, pressure switch 10 will be activated thus will be controlled by the pressure sensors. When pressure switch 10 is toggled to the “off” position, pressure switch 10 will be deactivated, thus inactivating the pressure sensors. Thus in this mode, the air pump 8 will be activated by a low pressure sensor and deactivated by a high pressure sensor embodied in pressure switch.

As is the case in other of the embodiments of the present invention, top plug 2 secures flexible conduit 3 to the top portion of bottle 1. Flexible conduit 3 sealingly extends through top plug 2 to about the bottom of the liquid contained within bottle 1. The other end of flexible conduit 3 includes valve 4. Valve 4 optionally includes a pen like clip (not shown) for securing that end to, e.g., the clothing, and the like, of the user. Air pump 8 is an integral part of unit 7 and communicates with the liquid volume contained within bottle 1 by air tube 9. The bottle 1 is filled with liquid indicate as indicated at about 13. Pressure switch 10 is typically activated during the entire period of liquid demand, e.g., the time period during physical activity. Activation of pressure switch 10, causes air pump 8 to force air into the bottle reservoir 6 through the air tube 9. Deactivation of valve 4 causes the pressure to rise within the bottle to the predetermined high pressure switch set point which in turn causes pressure switch 10 to deactivate pump 8.

When valve 4 is opened by the mouth and/or teeth of the athlete/user, the liquid will flow through the flexible conduit 3, forced by the pressure within bottle 1. The automated air pump/pressure switch unit 7 will maintain sufficient pressure within bottle 1 to accommodate liquid demand in response to the activation of mouth activated valve 4. Stated otherwise, so long as the valve 4 is activated by the mouth and/or teeth of the athelete/user, the minimum set point pressure will be tend to be maintained within the bottle 1 by unit 7 and air pump 8 will continue to be activated. Conversely, when valve 4 is de-activated, the pressure within the bottle 1 will rise to and/or above the predetermined high pressure set point and the air pump will be deactivated.

FIGS. 4A and 4B show the dispensing system 1 of FIG. 4 mounted on a bicycle. FIG. 4A shows flexible conduit 28 positioned in the non-drinking position, while FIG. 4B shows flexible conduit 28 positioned in the drinking position.

Preferrably, conduit 28 is constructed of a substantially rigid, flexible material and designed to enable it to be temporarily deformed. Although any suitable plastic material know to the prior art can be used to construct conduit 28, the preferred materials of contruction are polyethylene or polypropylene. Preferrably the bending joint of conduit 28 is typically formed in a well-known accordian-type construction which enables the conduit to be readily deformed into to either the drinking/non-drinking configurations.

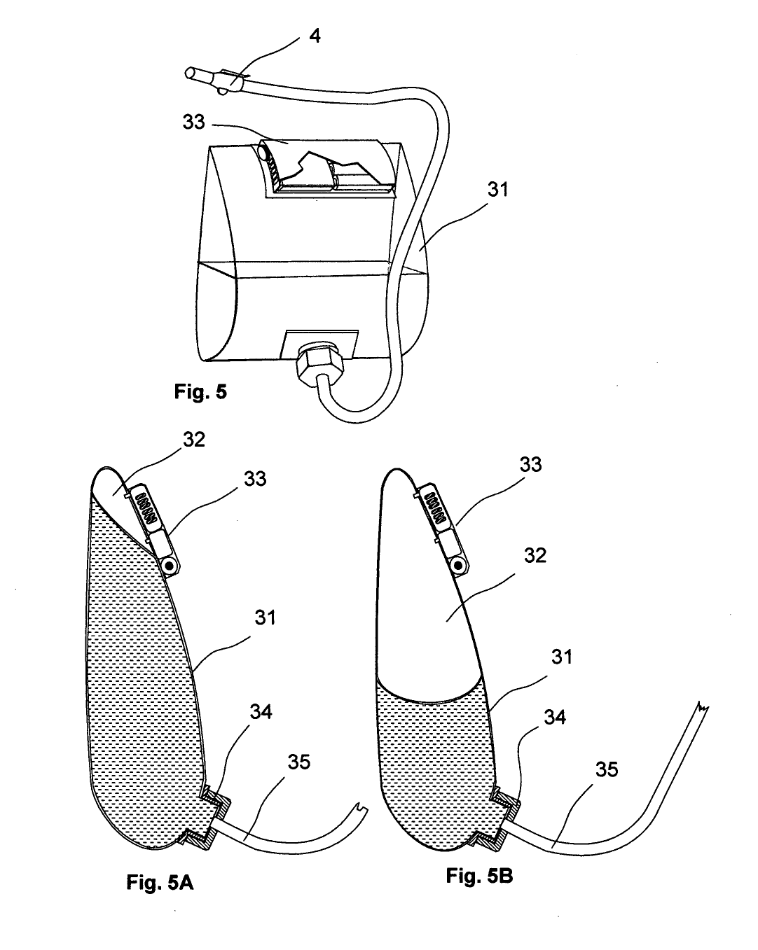

FIG. 5 shows an individual automated liquid dispensing system including a plastic, polymeric container 31.

FIGS. 5A and 5B show the automated liquid dispensing system installed at the top of plastic, polymeric container 31. FIG. 5A specifically shows air pump/pressure switch module unit 7 in its sealingly attached mode; while FIG. 5B specifically shows air pump/pressure switch module unit 7 in its detached mode. As described elsewhere herein with respect to the operation of basic system, when valve 4 is closed, the pressure raises until the upper limit pressure sensor de-activates the air pump (it should be noted that this automated system can be over-ridden with an optional on/off switch as described elsewhere herein). This embodiment is contemplated for runners, bicyclists, car racers, and for use during long distance travel. The application of this embodiment also contemplates use by handicapped individuals limited in mobility and hand dexterity.

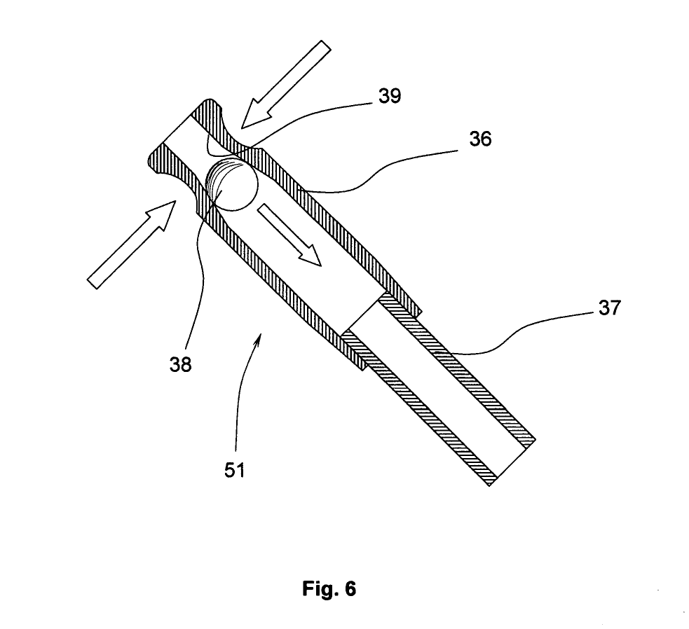

FIG. 6 shows the hands-free valve 36 located at the free end of flexible conduit 37. Hands-free valve 36 is designed to enable forced flow of the liquid stream to the user's mouth merely througth the pressure of the user's teeth and/or lips. The valve includes in a ball member 38 normally sealingly positioned in a seat indicated below about element 39. The ball is typically constructed of substantially any suitable hard, substantially non-deformable material, e.g., glass, metal, hard plastic, and the like. Of these materials, hard plastic is preferred. On the other hand, the seat and body indicated generally at 36 is constructed of a suitable, comparatively soft, deformable material of construction, such as, surgical rubber, silicone rubber, and the like. Of these materials, surgical rubber is preferred. In its de-activated mode, pressure within the automated dispensing system forces the ball against the seat portion of the valve thus impeding flow of the liquid through the dispensing tube. The valve is activated when the seat portion is deformed through the action of the mouth and/or teeth of the user. This deformation of the seat causes a liquid channel[s] to be formed between the interior of the depensing system and the mouth of the user, whereby pressurized liquid is caused to flow through the dispensing tube into the mouth of the user, until the pressure by the mouth and/or teeth of the user on the valve seat is relaxed.

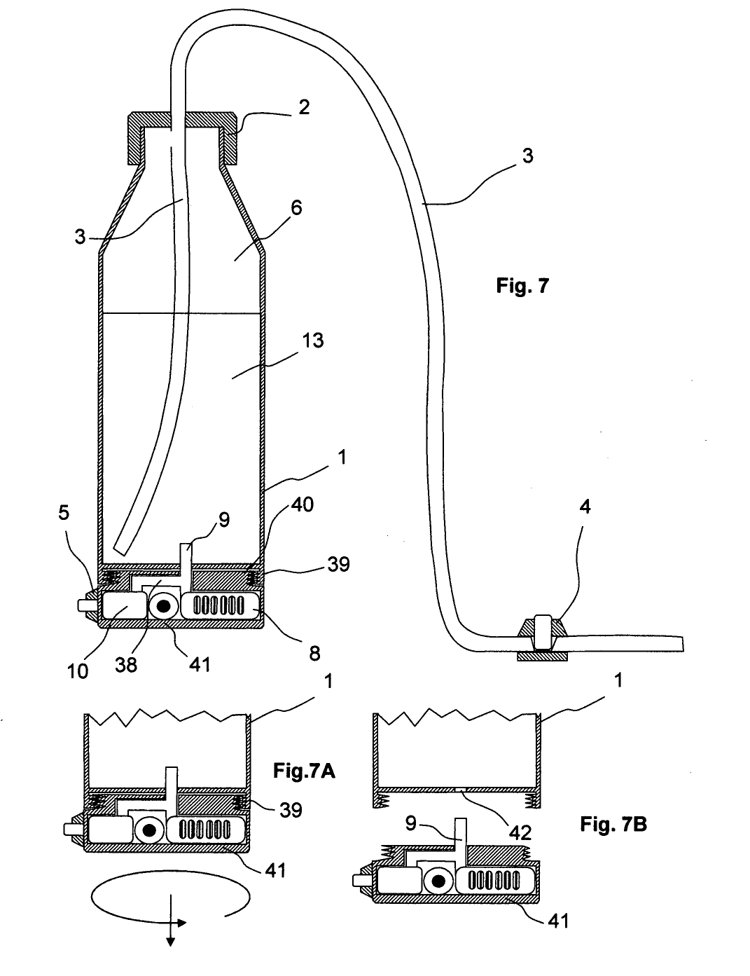

FIG. 7 shows the novel air pump/pressure switch unit as a detachably-attachable module unit 41. In this embodiment the module unit 41 includes in integrated construction: the air pump 8 with air intake (depicted as slots) and air discharge conduit 9; and, the pressure switch 10 with pressure sensors. The module unit 41 and bottle 1 are both threaded in such a manner that the module unit 41 can be screwed to the bottle to enable sealed communication; and conversely, unscrewed for removal from the bottle. As in the cases above, operation of this embodiment is essentially the same as describe above with respect to the generic embodiment of the present invention. As previously noted above, automated operation of all embodiments of the present invention can be over-ridden by an on/off switch.

FIG. 7A shows the embodiment of FIG. 7, wherein the module unit 41 is screwed to the bottle 1 for sealed communication between the module unit and the bottle in its integrated, attached condition.

FIG. 7B shows the embodiment of FIG. 7, wherein the module unit is un-screwed from the bottle 1 in its un-screwed, detached condition.

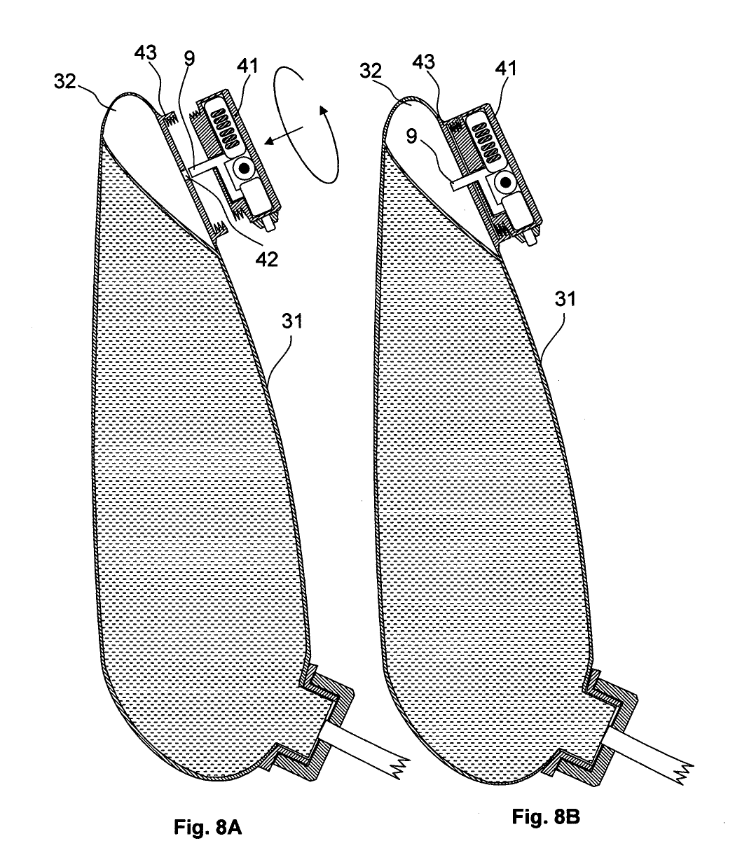

FIGS. 8A and 8B shows the module unit concept depicted in FIGS. 7, 7A and 7B adapted to a bag container 31. FIG. 8A shows the module unit 41 as it is un-screwed from the bag container 31 in its un-screwed, detached condition.

FIG. 8B shows the module unit 41 as it is sealingly screwed to the bag container 31 in its attached condition. Operation of this embodiment is essentially the same as describe above with respect to the generic embodiment of the present invention. As previously noted above, automated operation of all embodiments of the present invention can be over-ridden by an on/off switch.

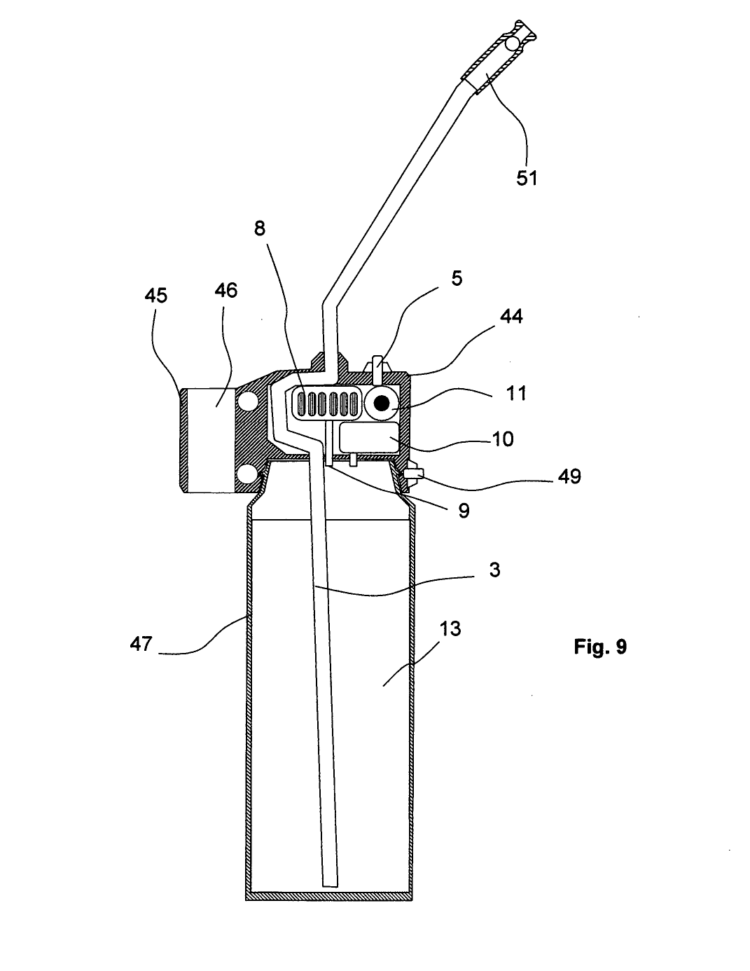

FIG. 9 show essentially all features of the embodiment[s] of FIGS. 7, 7A and 7B, save for the following refinements. First, the inventive module unit of the invention (indicated in FIG. 9 as element 44) is adapted to the form of a lid that is sealingly snapped to the top of bottle 47. Secondly, the dispensing conduit 3 has been integrated into the module unit 44. Otherwise, FIG. 9 shows module unit 44 in its sealingly attached condition.

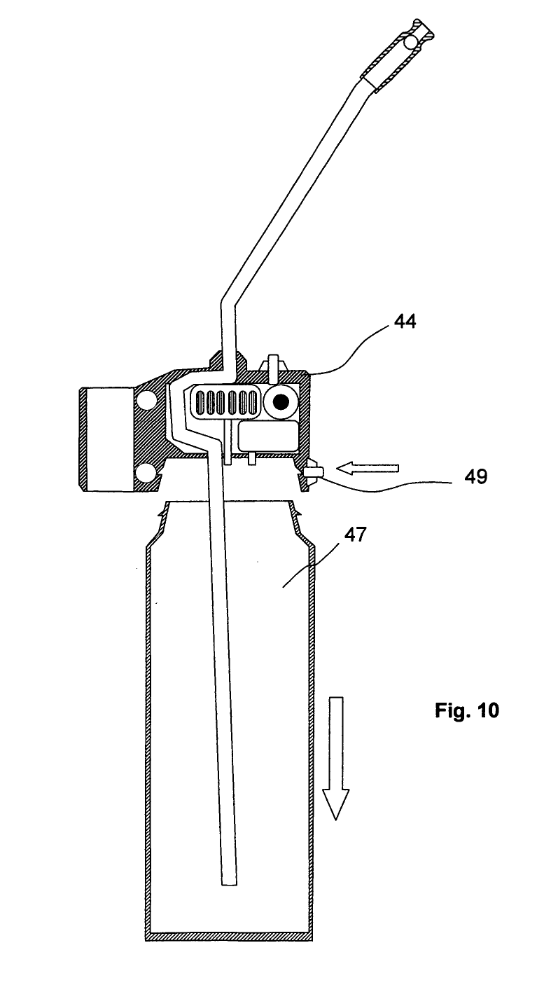

FIG. 10 shows the embodiment of FIG. 9 wherein module unit 44 is depicted in its detached mode. As in the cases above, operation of this embodiment is essentially the same as describe above with respect to the generic embodiment of the present invention. Again, as previously noted above, automated operation of all embodiments of the present invention can be over-ridden by an on/off switch.

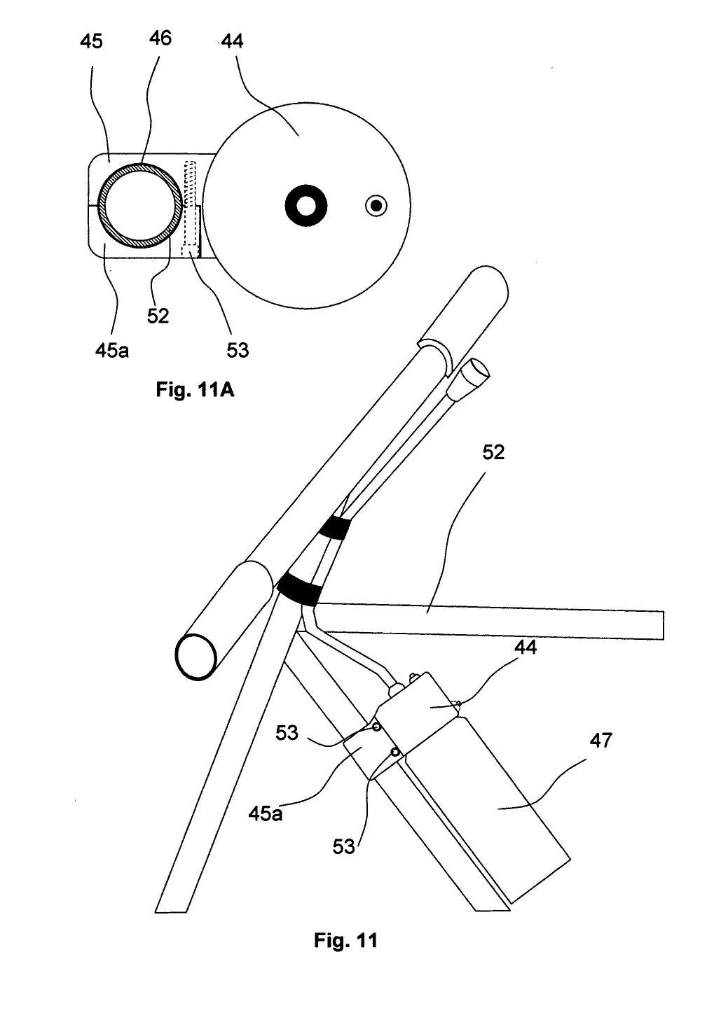

FIG. 11 shows the generic embodiment of the present invention 47 as mounted on a cross-member support of a bicycle 52.

FIG. 11A shows a plan view of the structure securing the preferred embodiment of FIG. 11. Specifically depicted are: clamp 45a and securing bolts 53. As in the cases above, operation of this embodiment is essentially the same as describe above with respect to the generic embodiment of the present invention. As previously noted above, automated operation of all embodiments of the present invention can be over-ridden by an on/off switch.

### DEFINITIONS

The symbol “™” as used herein refers to a trademark.

The term “polymeric” as used herein, refers to any suitable material of construction that the bottle or bag of the present invention may be constructed. Any suitable plastic presently know by the prior art is contemplated by the present invention. Particularly preferred are any species of polypropylene or polyelthylene and/or mixtures thereof.

Although the invention has been described with reference to certain preferred embodiments, it will be appreciated that many variations and modifications may be made within the scope of the broad principles of the invention. Hence, it is intended that the preferred embodiments and all of such variations and modifications be included within the scope and spirit of the invention, as defined by the following claims.

I claim:

1. An article for use in coorporation with a device for dispensing a liquid to an individual; wherein said device includes: a substantially fluid tight container having an interior for containing both said liquid and an airspace above said liquid; a conduit having a valve disposed therein, communicating with said liquid within said interior, for dispensing said liquid from said interior to said individual; said article comprising:
an air pump having an air intake and an air discharge;
means for securing a power source for driving said air pump;
means operatively communicating with said air pump for providing substantially constant on-demand flow when said valve is actuated;
means for sealingly, detachably attaching said article to said device;
means for detachably attaching said air discharge to communicate with said interior; and,
means for enabling communication of said means operatively communicating with said air pump, with said interior.

2. The article of claim 1, wherein said means means operatively communicating with said air pump is a pressure switch.

3. The article of claim 2, wherein said pressure switch further comprises:
a first pressure sensor designed, sized and dimensioned to active said air pump when the pressure in said fluid tight container is at about a first preselected pressure.

4. The article of claim 2, wherein said pressure switch further comprises:
a second pressure sensor designed, sized and dimensioned to de-active said air pump when the pressure in said fluid tight container is at about a second preselected pressure.

5. The article of claim 1, wherein said power source comprises at least one battery.

6. An article for use in cooperation with a device for dispensing a liquid to an individual; wherein said device includes: a substantially fluid tight container having an interior for containing both said liquid and an airspace above said liquid; said article comprising:
an air pump having an air intake and an air discharge;
means for securing a power source for driving said air pump;
means operatively communicating with said air pump for providing substantially constant on-demand flow when said valve is actuated;
means for detachably attaching said article to said device;
a conduit having a valve disposed therein, communicating with said liquid within said interior, for dispensing said liquid from said interior to said individual when said valve is actuated;
means for detachably attaching said air discharge to communicate with said interior, and,
means for enabling communication of said means operatively communicating with said air pump, with said interior.

7. The article of claim 6, wherein said means means operatively communicating with said air pump is a pressure switch.

8. The article of claim 7, wherein said pressure switch further comprises:
a first pressure sensor designed, sized and dimensioned to active said air pump when the pressure in said fluid tight container is at about a first preselected pressure.

9. The article of claim 7, wherein said pressure switch further comprises:
a second pressure sensor designed, sized and dimensioned to de-active said air pump when the pressure in said fluid tight container is at about a second preselected.

10. The article of claim 6, wherein said power source comprises at least one battery.

11. A device for dispensing a liquid to an individual; comprising:
a substantially fluid tight container having an interior for containing both said liquid and an airspace above said liquid;
a conduit having a valve disposed therein, communicating with said liquid within said interior, for dispensing said liquid from said interior to said individual;
an air pump having an air intake and an air discharge;
means for securing a power source for driving said air pump;
means operatively communicating with said air pump for providing substantially constant on-demand flow when said valve is actuated;
means for detachably attaching said article to said device;
means for detachably attaching said air discharge to communicate with said interior; and,
means for enabling communication of said means operatively communicating with said air pump, with said interior.

12. The device of claim 11, wherein said means means operatively communicating with said air pump is a pressure switch.

13. The device of claim 12, wherein said pressure switch further comprises:
a first pressure sensor designed, sized and dimensioned to active said air pump when the pressure in said fluid tight container is at about a first preselected pressure.

14. The device of claim 12, wherein said pressure switch further comprises:
a second pressure sensor designed, sized and dimensioned to de-active said air pump when the pressure in said fluid tight container is at about a second preselected.

15. The device of claim 11, wherein said power source comprises at least one battery.

16. The device of claim 11 wherein said container comprises a polmeric bag.

17. The device of claim 11 wherein said valve includes a substantially hard, non-deformable spherical ball seated in a substantially soft, deformable seat.

18. The device of claim 17 wherein said ball is constructed of a material selected from the group consisting of: glass, metal and hard, substantially non-deformable plastic.

19. The device of claim 17 wherein said seat is constructed of a material selected from the group consisting of: surgical rubber, silicone rubber, rubber, and soft, substantially deformable plastic.

20. The device of claim 11 further comprising:
a second container;
means for operatively communicating said second container to said container; and,
means for operatively communicating said second container to said conduit.
